(19) United States
(12) Patent Application Publication
(10) Pub. No.: US 2006/0161733 A1
(43) Pub. Date: Jul. 20, 2006

(54) Host buffer queues

(75) Inventors: Jeffrey Scot Beckett, Costa Mesa, CA (US); David James Duckman, Costa Mesa, CA (US); Alexander Nicolson IV, Costa Mesa, CA (US); William Weiguo Qi, Costa Mesa, CA (US); Michael Scully Jordan, Costa Mesa, CA (US)

Correspondence Address: EMULEX DESIGN & MANUFACTURING CORPORATION;C/O MORRISON & FOERSTER LLP, 555 WEST FIFTH STREET, SUITE 3500, LOS ANGELES, CA, 90013, US

(73) Assignee: Emulex Design & Manufacturing Corporation, Costa Mesa, CA (US)

(21) Appl. No.: 11/039,446

(22) Filed: Jan. 19, 2005

(51) Int. Cl. G06F 12/14; G06F 13/28

(52) U.S. Cl. 711/118

(57) ABSTRACT

The preferred embodiment of present invention is directed to an improved method and system for buffering incoming/unsolicited data received by a host computer that is connected to a network such as a storage area network. Specifically, in a host computer system in which the main memory of the host server maintains a I/O control block command ring, and which a connective port (e.g., a host bus adaptor) is operatively coupled to the main memory for handling I/O commands received by and transmitted from the host server, a host buffer queue (HBQ) is maintained for storing a series of buffer descriptors retrievable by the port for writing incoming/unsolicited data to specific address locations within the main memory. In an alternative embodiment of the present invention, multiple HBQs are maintained for storing buffer entries dedicated to different types and/or lengths of data, where each of the HBQ can be separately configured to contain a selection profile describing the specific type of data for which the HBQ is dedicated to service.

### BACKGROUND OF THE INVENTION

1. Field of the Invention

The present invention relates to a method and system for managing temporary. storage of data by a host of a computer system; more particularly, the present invention relates to the use of buffer queues in a computer system for temporary data storage.

2. Description of Related Art

FIG. 1 illustrates a block diagram of a host system 10 for a storage area network (SAN). The host system 10 includes a conventional host server 12 that executes application programs 14 in accordance with an operating system program 16. The server 12 also includes necessary driver software 18 for communicating with peripheral devices. The server 12 further includes conventional hardware components 20 such as a CPU (not shown), host memory (e.g., ROM or hard disk drive) (not shown), RAM (not shown), cache (not shown), etc., which are well known in the art.

The server 12 communicates via a peripheral component interconnect (PCI or PCIX) host bus interface 22 to a host bus adaptor (HBA) 24, which handles the I/O operations for transmitting and receiving data to and from remote Fibre Channel disk storage devices 28 via a Fibre Channel fabric 26. Host bus adapters (HBAs) are well-known peripheral devices that handle data input/output (I/O) operations for host devices and systems (e.g., servers). In simple terms, a HBA provides I/O processing and physical connectivity between a host device and external data storage devices. The external storage devices may be connected using a variety of known “direct attached” or storage networking technologies, including Fibre Channel, iSCSI, VI/IP, FICON, or SCSI. HBAs provide critical server CPU off-load, freeing servers to perform application processing. HBAs also provide a critical link between the storage area networks and the operating system and application software residing within the server. In this role the HBA enables a range of high-availability and storage management capabilities, including load balancing, SAN administration, and storage management.

Other host systems 30 may also be operatively coupled to the Fibre Channel fabric 26 via respective HBAs 32 in a similar fashion. The server 12 may communicate with other devices 36 and/or clients or users (not shown) via an Ethernet port/interface 38, for example, which can communicate data and information in accordance with well-known Ethernet protocols. Various other types of communication ports, interfaces and protocols are also known in the art that may be used by the server 12. The server 12 may also be connected to the Internet 40 via communication port/interface 38 so that remote computers (not shown) can communicate with the server 12 using well-known TCP/IP protocols. Additionally, the server 12 may be connected to local area networks (LANS) (not shown) and/or wide area networks (WANs) (not shown) in accordance with known computer networking techniques and protocols.

A schematic representation of a portion of the memory configuration of the server 12 and the HBA 24 is illustrated in FIG. 2. As discussed above, the server 12 and the HBA 24 must frequently communicate over the host bus interface 22. For example, the server 12 may ask for service from the HBA 24 via a command, or configure itself to receive asynchronous information, and be notified when the asynchronous information is available or when the commands have been completed. To facilitate these communications, the server main memory 132 includes a command ring 108 and a response ring 110 in main memory 132, which may comprise a circular queue or other data structure that performs a similar function. In general, rings are used to pass information across the host bus interface 22 from the server 12 to the HBA 24, or vice versa.

The command ring 108 stores command representations such as command I/O control blocks (IOCBs) 148 that are to be presented to the HBA 24. A command IOCB 148 contains all of the information needed by the HBA 24 to carry out a Input/Output command to another device. The information may include the destination device, a pointer to the address of the data being transferred and the length of the data that can be stored (e.g., data buffer descriptor).

When the server 12 writes a command IOCB 148 into the command ring 108, it also increments a put pointer 144 to indicate that a new command IOCB 148 has been placed into the command ring 108. When the HBA 24 reads a command IOCB 148 from the command ring 108, it increments a get pointer 146 to indicate that a command IOCB 148 has been read from the command ring 108. In general (excluding for the moment the fact that the command ring 108 is a circular ring that wraps around), if the put pointer 144 is equal to the get pointer 146, the command ring 108 is empty. If the put pointer 144 is ahead of the get pointer 146, there are commands 148 in the command ring 108 to be read by the HBA 24. If the put pointer 144 is one less than the get pointer 146, the command ring 108 is full.

The response ring 110 stores response indicators such as response IOCBs 156 of asynchronous events written by the HBA 24, including notifications of unsolicited events such as incoming data from a remote system. Response IOCBs 156 contain all of the information needed by the server 12 to carry out the command. For example, one such response IOCB 156 may require that the server 12 initiate a new command. When the HBA 24 writes a response IOCB 156 into the response ring 110, it also increments a put pointer 150 to indicate that a new response IOCB 156 has been placed into the response ring 110. When the server 12 reads a response IOCB 156 from the response ring 110, it increments a get pointer 152 to indicate that a response IOCB 156 has been read from the response ring 110.

The server 12 also includes a collection of pointers such as a port pointer array 106 that reside in the main memory 132. The port pointer array 106 contains a list of pointers that can be updated by the HBA 24. These pointers are entry indexes into the command ring 108, response ring 110, and other rings in the server 12. For example, the port pointer array 106 contains the get pointer 146 for the command ring 108 and the put pointer 150 for the response ring 110. When updated, these pointers indicate to the server 12 that a command IOCB 148 has been read from the command ring 108 by the HBA 24, or that a response IOCB 156 has been written into the response ring 110 by the HBA 24.

The HBA memory 50 includes a host bus configuration area 126 that contains information for allowing the host system 10 to identify the type of HBA 24 and what its characteristics are, and to assign base addresses to the HBA 24 so that programs can talk to the HBA 24. The HBA memory 50 further stores hardware execution program instructions and processing data to be processed by the microprocessor. The HBA memory 50 typically also includes a collection of pointers such as a host pointer array 128. The host pointer array 128 contains a list of pointers that can be updated by the server 12. These pointers are entry indexes into the command ring 108, response ring 110, and other rings in the server 12. For example, the host pointer array 128 contains the put pointer 144 for the command ring 108 and the get pointer 152 for the response ring 110. When updated, these pointers indicate to the HBA 24 that a command IOCB 148 has been written into the command ring 108 by the server 12, or that a response IOCB 156 has been read from the response ring 110 by the server 12.

When the HBA 24 has completed the processing of a command from the server 12, the HBA 24 first examines the get pointer 152 for the response ring 110 stored in the host pointer array 128 and compares it to the known put pointer 150 for the response ring 110 in order to determine if there is space available in the response ring 110 to write a response entry 156. If there is space available, the HBA 24 becomes master of the host bus interface 22 and performs a direct memory access (DMA) operation to write a response IOCB 156 into the response ring 110, and performs another DMA operation to update the put pointer 150 in the port pointer array 106, indicating that there is a new response IOCB 156 to be processed in the response ring 110. The HBA 24 then writes the appropriate attention conditions into a host attention register (not shown), and triggers the generation of an interrupt.

In the event that a remote system sends an I/O command to the server 12, the HBA's function is to transfer the unsolicited/incoming data to the appropriate processor device in order to process the incoming data. Before the incoming data can be processed, the HBA must place the incoming data into a buffer memory for safe storage until the data can be processed by the server 12. In a conventional host system 10, the incoming data is stored at a location within main memory 132, the location being specified by a specialized IOCB (also referred to as a buffer descriptor IOCB) delivered via the command ring 108. A buffer descriptor IOCB contains information that specifies an address within main memory 132 at which unsolicited/incoming data may be temporarily stored, and the amount of data that may be stored at that location. In anticipation of unsolicited/incoming data, the server 12 periodically places buffer descriptor IOCBs into the command ring 108 to be read by the HBA 24, which stores the buffer descriptor IOCBs in the HBA memory 50 in a link-list fashion (commonly referred to as the queue ring buffer). Whenever unsolicited/incoming data is received by the HBA 24 from the Fibre Channel fabric 26, the HBA 24 stores the incoming data into a memory location within the main memory 132 that is specified by one or more of the stored buffer descriptors.

Because the host system 10 does not know of the exact frequency or the size of data that may be received by the HBA 24 at any given time, the host system 10 needs to be configured to provide sufficient number of buffer descriptor IOCBs to the HBA 24 so as to properly anticipate the incoming/unsolicited data. In the event HBA 24 receives incoming data but does not have any stored buffer descriptor IOCBs due to lack of proper anticipation by the host system 10, then the HBA 24 will request to the server 12 via an interrupt to request that additional buffer descriptor IOCBs be sent to the HBA 24. If no additional buffer descriptor IOCB is sent to the HBA 24, or if the buffer descriptor IOCB is sent untimely, then the incoming data would be dropped from the HBA 24. On the other hand, if the host system 10 overly anticipates the incoming data traffic and sends to the HBA 24 an excess number of buffer descriptor IOCBs, then such a condition results in inefficient use of memory space in main memory 132 as portions of the memory may be unnecessarily dedicated to the queue ring buffer, as well as in HBA memory 50 to store excessive buffer descriptors.

### SUMMARY OF THE EMBODIMENTS OF THE PRESENT INVENTION

It is an object of the present invention to provide a new method and apparatus for managing temporary storage of incoming/unsolicited data received by the HBA 24 so as to make more efficient use of the host main memory 132, to reduce bus transactions related to the processing of buffer descriptor IOCBs from the command ring, to reduce the usage of HBA memory 50 in storing the buffer descriptors, and to ensure. that incoming/unsolicited data would not be dropped for reasons of unavailable storage buffer. Specifically, the preferred embodiments of the present invention provides separate data structure (hereinafter referred to as a host buffer queue or HBQ) to serve as a memory location or a separate memory device that is dedicated for handling incoming/unsolicited data received by the HBA 24. In accordance with an alternative embodiment, a plurality of host buffer queues may be provided, each configured to be dedicated to different types of data or data of different lengths. Details of the HBQ and its operation are described in detail below.

### BRIEF DESCRIPTION OF THE DRAWINGS

FIG. 1 is a schematic illustration of a storage area network environment in which a host system is located;

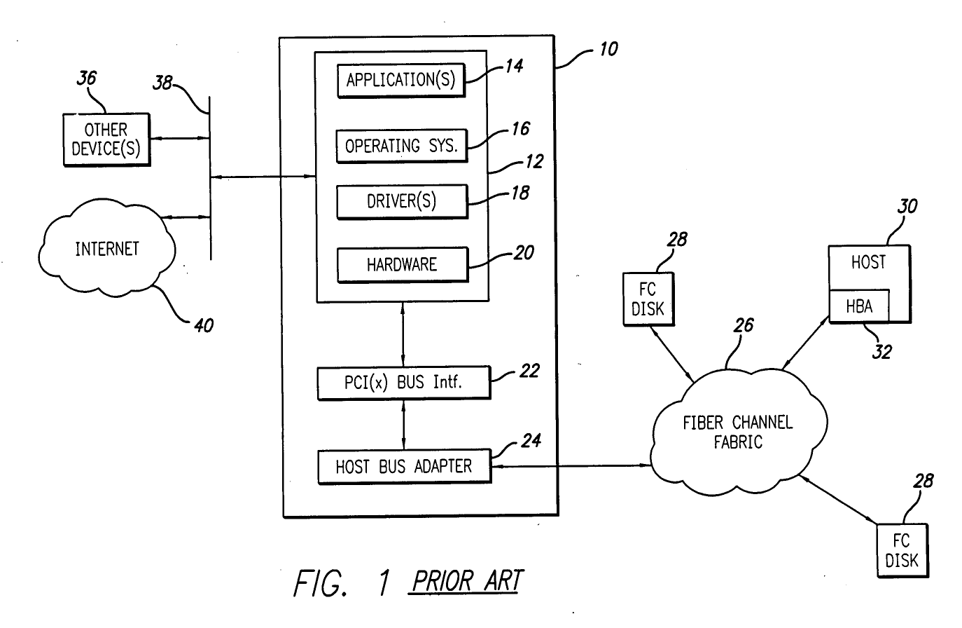

FIG. 2 is a schematic illustration of the certain data structures residing in the memory. of the host server and the host bus adaptor;

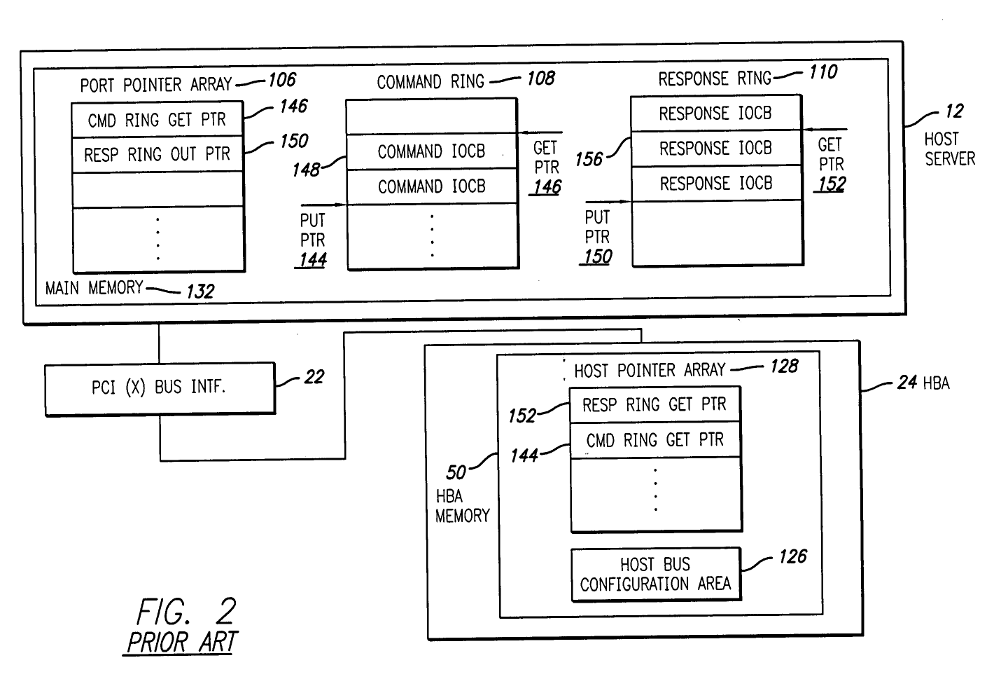

FIG. 3 is a schematic illustration of host buffer queue data structure in accordance with a preferred embodiment of the present invention; and

FIG. 4 is a schematic illustration of a plurality of host buffer queue data structures in accordance with an alternative embodiment of the present invention.

### DETAILED DESCRIPTION OF THE PREFERRED EMBODIMENTS

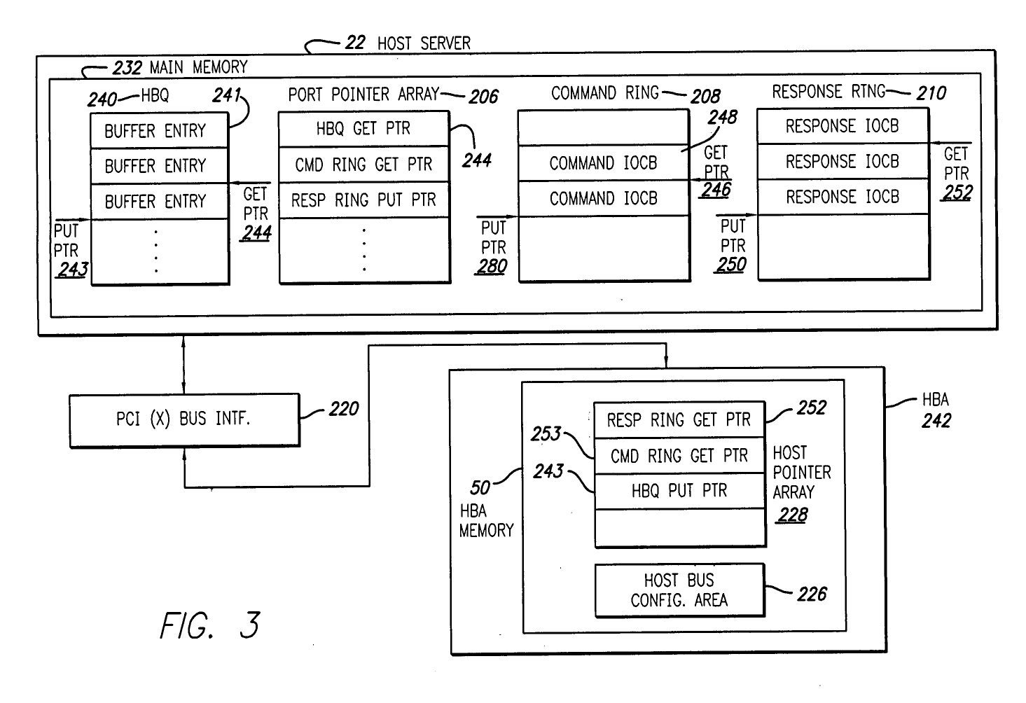

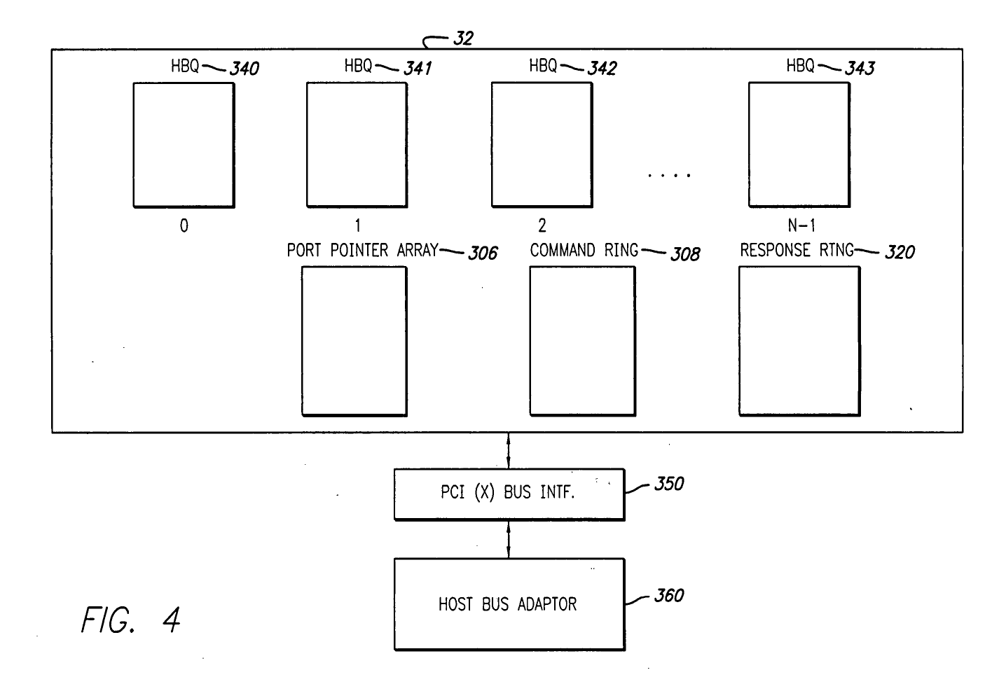

The preferred embodiments of the present invention will now be described with references to FIGS. 3 and 4.

FIG. 3 shows a schematic illustration of a main memory 232 that is resident in a host server 22, which is operatively coupled to the host bus adaptor (HBA) 242 via the bus interface 220. The main memory 232 is configured to include the port pointer array 206, command ring 208, and the response ring 220, all of which operate similarly to the port pointer array 106, command ring 108, and the response ring 120 as described above. In accordance with the preferred embodiment of the present invention, the main memory 232 of the server 22 includes a host buffer queue (HBQ) 240, which preferably consist of a contiguous area of the main memory 232 (e.g., a ring buffer) that can contain a host-defined number of buffer entries.

Associated with the HBQ 240 is a HBQ put pointer 243 and a HBQ get pointer 244; the mechanics of adding and removing buffer queue entries to and from HBQ 240, and the use of the get and the put pointers, are identical to the adding and removing of the IOCB commands from the IOCB ring 108 as described above. As shown in FIG. 3, the HBQ put pointer 243 is contained in the host pointer array, while the HBQ get pointer is included in the port pointer array. In operation, whenever HBA 240 receives unsolicited/incoming data that needs to be temporarily stored, the HBA 240 compares the HBQ put pointer 243 and the HBQ get pointer 244 to determine that a buffer entry is available in HBQ 240. If a buffer descriptor is present, the HBA 240 writes the received data into a memory location in accordance with the buffer descriptor that corresponds to the then current position of the HBQ get pointer 244. After the data is written into the memory location, the HBA 240 increments the get pointer 244 to indicate to the host server 22 that a buffer descriptor has been used by the HBA 242. The buffer descriptors that are stored in the HBQ 240 can be similar in structure to the buffer descriptors written into the IOCB command ring 108 as described in the Background section, wherein each buffer descriptor contains information relating to an address within the main memory 232 for storing data, and the maximum length of data that can stored at that memory location.

Similar to the operations of the get/put pointers of the command ring, if the put pointer 243 is equal to the get pointer 244, then the HBQ is empty. If the put pointer 243 is ahead of the get pointer 244, and if the put pointer is one less than the get pointer 244, then the HBQ 240 is full (i.e., there are no additional memory storage spaces available).

In accordance with the preferred embodiment, the HBA has the ability to, via a direct memory access operation, read more than one buffer descriptor at a time from the HBQ, and can temporarily store these buffer descriptors in the HBA memory until they are needed for the incoming/unsolicited data. By reading multiple buffer descriptors from the HBQ at a time, the preferred embodiment can further reduce bus transactions.

In accordance with an alternative embodiment of the present invention, as shown in FIG. 4, a plurality of HBQs 340, 341, .342 to 343 can be configured in the server 32. The different HBQs can be configured differently by the host system to be dedicated for providing buffer descriptors for storing different types of data. Specifically, each HBQ is preferably configured to have a different profile selection criteria that defines a test the HBA 360 must perform when attempting to match a buffer entry request with a particular HBQ.

For instance, a host running a Fibre Channel Protocol (“FCP”) Target can configure the IOCB response ring 320 to receive both the FCP command IU and first burst data. The host can then configure HBQ 340 for providing buffer descriptors for storing command IU type data, and HBQ 341 for providing buffer descriptors for storing all other types of data, such as burst data. In a Fibre Channel system, incoming data can be identified as either Command IU or burst data by examining the R_CTL/Type fields in the header of the data frame. Accordingly, the host can direct the HBA 360 to examine the R_CTL/Type of the incoming data, and direct any data identified as Command IU data to a buffer described by a buffer descriptor from HBQ 340, and direct any data identified, as burst data to a buffer described by a buffer descriptor from HBQ 341. In such an instance, when a Command IU is received, the HBA 360 can post an IOCB using the buffer entries stored in HBQ 340. Thereafter, a first burst data can be returned in a subsequent IOCB response using the HBQ 341 buffer entries. Because there are different HBQs that may be used, different sizes of buffers can be used for storing the command IU and the first burst data, resulting in more efficient allocation of memory space.

In accordance with another alternative embodiment of the present invention, where a host system is configured to maintain multiple HBQs with different profile selection criteria, one of the HBQs is preferably configured to be a default HBQ for storing data of any type. The configuration of a default HBQ provides a failsafe for situations where the incoming data received may not match the selection profile of any of the HBQs. Accordingly, if the HBA 360 cannot match the data type of an incoming data, the HBA can direct that unidentified data to buffer entries from the default HBQ for storage and processing.

In accordance with yet another alternative embodiment of the present invention, where a host system is configured to maintain multiple HBQs with different profile selection criteria, the host system can be configured to provide the user with an optional “on/off” option for activating or deactivating the profile selection criteria. If the user chooses to deactivate the profile selection criteria, then all of the HBQs will be available to the HBA 360 for storing data of any type.

In an environment where a host system is configured to maintain multiple IOCB command rings, for each IOCB response ring, one or more HBQs may be associated with that particular IOCB response ring and be dedicated to service incoming data that are associated with that particular IOCB ring. In situations where multiple HBQs are associated with one particular IOCB response ring, further differentiation amongst the HBQs can be made using different profile selection criteria in the manner described above. The distinction amongst the HBQs for different IOCB command rings, and for different types of data, allows for the host system to be configured to maximize the memory use efficiency of the host bus system.

In accordance with yet another embodiment of the present invention, where multiple HBQs are employed to service an IOCB command ring, in addition to distinguishing the HBQs using selection profile such as different R_CTL/Type data profile, HBQs can be further distinguished by data length characteristics. Specifically, in instance where multiple HBQs are used, and in instances where two or more HBQs may share the same data-type selection profile, the host system can be configured to further distinguish amongst the two or more HBQs by configuring the HBQs to accept data of specific length.

It should be noted that the present invention may be embodied in forms other than the preferred embodiments described above without departing from the spirit or essential characteristics thereof. The specification contained herein provides sufficient disclosure for one skilled in the art to implement the various embodiments of the present invention, including the preferred embodiment, which should be considered in all aspect as illustrative and not restrictive; all changes or alternatives that fall within the meaning and range or equivalency of the claim are intended to be embraced within. For instance, if a user wishes to further distinguish between multiple HBQs beyond R_CTL/Type and data length selection profile, such as using the command code characteristics of the data or header information of the data, the user may configure the selection profiles of the HBQs to include further selection restrictions based on additional distinguishable characteristics of incoming data frames.

What is claimed:

1. A method for temporarily storing data within a host server computer system, said host server computer system having a main memory, said method comprising the steps of:
designating a contiguous portion of said main memory as a host buffer queue, said host buffer queue having a plurality of memory address descriptors;
receiving incoming data;
retrieving, from said host buffer queue, one of said plurality of memory address descriptors, said one memory address descriptor specifying a physical location within said main memory; and
storing to said physical location the received incoming data.

2. The method of claim 2, further comprising the steps of:
looking up a host buffer queue put pointer, said host buffer queue put pointer indicating a location within the host buffer queue at which said one memory address descriptor is stored; and
incrementing the host buffer queue put pointer to indicate a next location within the host buffer queue.

3. The method of claim 1, further comprising the steps of:
configuring a selection profile for said host buffer queue, said selection profile specifying a type of data to be serviced by said host buffer queue;
reading a header portion of said incoming data; and
determining, from said header portion, whether said incoming data matches the type of data specified by said selection profile.

4. The method of claim 1, further comprising the steps of:
looking up a host buffer queue get pointer, said host buffer queue get pointer indicating the location within the host buffer queue at which said one memory address descriptor is stored;
retrieving, from said host buffer queue, said one memory address descriptor, said one memory address descriptor specifying the physical location within said main memory at which said incoming data is stored; and
reading the incoming data from the physical location of said main memory.

5. The method of claim 4, further comprising the step of incrementing the host buffer queue get pointer to indicate a next location within said host buffer queue.

6. A method for temporarily storing data within a host server computer system, said host server computer system having a main memory, said method comprising the steps of:
designating a plurality of contiguous portions of said main memory as a plurality of host buffer queues, each of said host buffer queue having a plurality of memory address descriptors;
configuring a selection profile for each of said plurality of host buffer queues, each of the selection profiles specifying a type of data to be serviced by the corresponding host buffer queue;
receiving incoming data;
reading a portion of the incoming data to determine the type of incoming data;
comparing the determined type of incoming data with the selection profiles of said plurality of host buffer queues;
selecting one of said plurality of host buffer queues, said one host buffer queue having a selection profile matching the determined type of incoming data;
retrieving, from said one host buffer queue, one of the plurality of memory address descriptors, said one memory address descriptor specifying a physical location within said main memory;
storing to said physical location the received incoming data.

7. The method of claim 6, further comprising the steps of:
designating a portion of said main memory as a default host buffer queue, said default host buffer queue having a plurality of default memory address descriptors; and
if the determined type of incoming data does not match any of the selection profile of the plurality of host buffer queues, retrieving, from said default host buffer queue, one of the plurality of default memory address descriptors, said one default memory address descriptor specifying a physical location within said main memory;
storing the received incoming data to the physical location within said main memory specified by said one default memory address descriptor.

8. The method of claim 6, wherein said portion of said incoming data is the header data of the incoming data.

9. The method of claim 6, further comprising the step of determining whether the selection profiles of the plurality of host buffer queues are activated.

10. A host server computer system operatively coupled to a network of computers, said host server computer system comprising:
a host server computer, said host server computer comprising a main memory, wherein a contiguous portion of said main memory is designated as a host buffer queue, said host buffer queue comprising a plurality of memory address descriptors for specifying a physical location of said main memory; and
a peripheral device for receiving incoming data from said network and for handling I/O operation of said host server computer, said peripheral device operatively coupled to said host server computer,
wherein, upon receiving incoming data, said peripheral device retrieves, from said host buffer queue, one of said plurality of memory address descriptors and causes the incoming data to be stored in the physical location of the main memory specified by said one memory address descriptor.

11. The host server computer system of claim 10, wherein said peripheral device is a host bus adaptor.

12. A host server computer system operatively coupled to a network of computers, said host server computer system comprising:
a host server computer, said host server computer comprising a main memory, wherein a plurality of contiguous portions of said main memory are designated as a plurality of host buffer queues, wherein each of said plurality of host buffer queue comprises a plurality of memory address descriptors for specifying physical locations within said main memory, and wherein each of said plurality of host buffer queues are configured to service a particular type of data; and
a peripheral device for receiving incoming data from said network and for handling I/O operation of said host server computer, said peripheral device operatively coupled to said host server computer,
wherein, upon receiving incoming data, peripheral device reads a portion of the incoming data to determine a type of the incoming data, and retrieves, from a host buffer queue having a configuration for servicing the type of data matching the type of incoming data, a memory address descriptors for causing the incoming data to be stored in a physical location of the main memory specified by said one memory address descriptor.

13. The host server computer system of claim 12, wherein said peripheral device is a host bus adaptor.

14. A host server computer system operatively coupled to a network of computers, said host server computer system comprising:
a host server computer, said host server computer comprising a main memory, wherein a contiguous portion of said main memory is designated as a host buffer queue, said host buffer queue comprising a plurality of memory address descriptors for specifying a physical location of said main memory; and
means for receiving incoming data from said network;
means for retrieving, from said host buffer queue, one of said plurality of memory address descriptors; and
means for writing to said physical location the received incoming data.

15. The host server computer system of claim 14, further comprising:
means for looking up a host buffer queue put pointer, said host buffer queue put pointer indicating a location within the host buffer queue at which said one memory address descriptor is stored; and
means for incrementing the host buffer queue put pointer to indicate a next location within the host buffer queue.

16. The host server computer system of claim 14, further comprising:
means for configuring a selection profile for said host buffer queue, said selection profile specifying a type of data to be serviced by said host buffer queue;
means for reading a header portion of said incoming data; and
means for determining, from said header portion, whether said incoming data matches the type of data specified by said selection profile.

17. The host server computer system of claim 14, further comprising the steps of:
means for looking up a host buffer queue get pointer, said host buffer queue get pointer indicating the location within the host buffer queue at which said one memory address descriptor is stored;
means for retrieving, from said host buffer queue, said one memory address descriptor, said one memory address descriptor specifying the physical location within said main memory at which said incoming data is stored;
means for reading the incoming data from the physical location of said main memory; and
means for incrementing the host buffer queue get pointer to indicate a next location within said host buffer queue.

18. A host server computer system operatively coupled to a network of computers, said host server computer system comprising:
a host server computer, said host server computer comprising a main memory, wherein a plurality of contiguous portions of said main memory are designated as a plurality of host buffer queues, wherein each of said plurality of host buffer queue comprises a plurality of memory address descriptors for specifying physical locations within said main memory, and wherein each of said plurality of host buffer queues are configured to service a particular type of data; and
means for receiving incoming data from said network;
means for reading a portion of the incoming data to determine the type of incoming data;
means for comparing the determined type of incoming data with the selection profiles of said plurality of host buffer queues;
means for selecting one of said plurality of host buffer queues, said one host buffer queue having a selection profile matching the determined type of incoming data,
means for retrieving, from said one host buffer queue, one of the plurality of memory address descriptors, said one memory address descriptor specifying a physical location within said main memory;
means for writing to said physical location the received incoming data.

19. A peripheral device operatively coupled to a host server computer for handling I/O operations of said host server computer, said host server computer having a main memory, wherein a portion of the main memory is designated as a host buffer queue containing a plurality of memory address descriptors for specifying physical locations of the main memory, said peripheral device comprising:
means for receiving incoming data;
means for retrieving, from said host buffer queue, one of said plurality of memory address descriptors; and
means for causing the incoming data to be stored to the physical location of the main memory specified by said one memory address descriptor.

20. The peripheral device of claim 19, further comprising:
means for looking up a host buffer queue put pointer, said host buffer queue put pointer indicating a location within the host buffer queue at which said one memory address descriptor is stored; and
means for incrementing the host buffer queue put pointer to indicate a next location within the host buffer queue
